(19) United States
(12) Patent Application Publication
(10) Pub. No.: US 2018/0350055 A1
(43) Pub. Date: Dec. 6, 2018

(54) AUGMENTED REALITY FEATURE DETECTION

(71) Applicant: Tesla, Inc., Palo Alto, CA (US)

(72) Inventor: Ivan Cardenas Bernal, Fremont, CA (US)

(21) Appl. No.: 15/994,914

(22) Filed: May 31, 2018

Related U.S. Application Data
(60) Provisional application No. 62/513,902, filed on Jun. 1, 2017.

(51) Int. Cl. G06T 7/00; G06T 19/00; G06F 17/50; G06T 7/55

(52) U.S. Cl. CPC G06T 7/001; G06T 19/006; G06T 2207/30108; G06T 7/55; G06T 2207/30204; G06F 17/5095

(57) ABSTRACT

An image is obtained. Based on hues of the image, a model of the image is generated. A reduced model associated with a manufactured item is received. The reduced model associated with the manufactured item is generated by reducing an original model associated with the manufactured item. An attempt is made to match at least a portion of the reduced model with the model of the image.

### CROSS REFERENCE TO OTHER APPLICATIONS

This application claims priority to U.S. Provisional Patent Application No. 62/513,902 entitled AUGMENTED REALITY APPLICATION FOR MANUFACTURING filed Jun. 1, 2017 which is incorporated herein by reference for all purposes.

### BACKGROUND OF THE INVENTION

Existing automotive manufacturing techniques are both time consuming and require significant manual calibration and inspection. The positioning and programming of robots for constructing and assembling automotive parts, the marking and placement of mechanical joints, the quality inspection of assembled parts, etc. require a worker specifically trained to perform tasks that include setup, configuration, calibration, and/or inspecting the quality of the work and results. The time required to perform the steps is extensive and increases the time and cost to build a new vehicle. For example, a current practice for marking joints and/or inspecting dimensional accuracy of the joints involves overlaying paper or plastic molds over a sheet metal object in order to mark the part. Similarly, joints may be inspected by manually referencing adjacent features, molds, or using coordinate measuring machine (CMM) inspection. Therefore, there exists a need for a process and tools for increasing the efficiency and decreasing the cost of automotive manufacturing tasks. Applying computer vision and augmented reality tools to the manufacturing process can significantly increase the speed and efficiency related to manufacturing and in particular to the manufacturing of automobile parts and vehicles.

### BRIEF DESCRIPTION OF THE DRAWINGS

Various embodiments of the invention are disclosed in the following detailed description and the accompanying drawings.

FIG. 1 is a flow diagram illustrating an embodiment of a process for applying augmented reality to manufacturing.

FIG. 2 is a flow diagram illustrating an embodiment of a process for matching an object of interest to a reference model.

FIG. 3 is a flow diagram illustrating an embodiment of a process for matching an object of interest to a reference model.

FIG. 4 is a flow diagram illustrating an embodiment of a process for preparing reference data for an augmented reality manufacturing application.

FIG. 5 is a flow diagram illustrating an embodiment of a process for applying augmented reality to manufacturing.

FIG. 6 is a flow diagram illustrating an embodiment of a process for applying augmented reality to manufacturing.

FIG. 7 is a block diagram illustrating an embodiment of an augmented reality system for manufacturing.

FIG. 8 is a diagram illustrating a model of assembled manufactured items for an embodiment of an augmented reality manufacturing application.

FIG. 9 is a diagram illustrating an embodiment of a user interface for an augmented reality manufacturing application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An augmented reality (AR) application for manufacturing is disclosed. In some embodiments, computer vision and augmented reality techniques are utilized to identify an object of interest and the relationship between a user and the object. For example, a user has an AR device such as a smartphone that includes a camera and sensors or a pair of AR smart glasses. In some embodiments, the AR glasses may be in the form of safety glasses. The AR device captures a live view of an object of interest, for example, a view of one or more automotive parts. The AR device determines the location of the device as well as the location and type of the object of interest. For example, the AR device identifies that the object of interest is a right hand front shock tower of a vehicle. The AR device then overlays data corresponding to features of the object of interest, such as mechanical joints, interfaces with other parts, thickness of e-coating, etc. on top of the view of the object of interest. Examples of the joint features include spot welds, self-pierced rivets, laser welds, structural adhesive, and sealers, among others. As the user moves around the object, the view of the object from the perspective of the AR device and the overlaid data of the detected features adjust accordingly. The user can also interact with the AR device. For example, a user can display information on each of the identified features. In some embodiments, for example, the AR device displays the tolerances associated with each detected feature, such as the location of a spot weld or hole. As another example, the overlaid data on the view of the object includes details for assembly, such as the order to perform laser welds, the type of weld to perform, the tolerance associated with each feature, whether a feature is assembled correctly, etc. In various embodiments, the AR device detects features of a physical object and displays digital information interactively to the user. The data associated with the object of interest is presented to help the user more efficiently perform a manufacturing task.

In some embodiments, the applications and techniques disclosed herein apply to the context of both augmented reality (AR) and mixed reality (MR). In various embodiments, the AR applications disclosed herein are not limited to augmented elements and may include functionality to receive user interaction and to manipulate digital components. In some embodiments, the applications are MR and/or extended reality (XR) applications. For example, using the disclosed techniques, real world and virtual world environments are combined. In various embodiments, a human user (and/or robot) can interface with the combined environment.

There are many practical applications for the augmented reality (AR) manufacturing techniques discussed herein. For example, in some embodiments, the AR device is used to program a robot to assemble one or more parts including identifying and marking the precise location and order of welds, self-pierced rivets, laser welds, adhesives, sealers, holes, fasteners, or other mechanical joints, etc. As another example, the AR device can be used to inspect the quality of the assembly for a vehicle such as whether the locations of welds are correct, whether the interfaces between parts such as body panels are within tolerances, whether holes are drilled or punched at the correct location, whether the fit and finish of assembly is correct, etc. In some embodiments, vision recognition is utilized. Individual sheet metal components and/or assemblies that are or will be part of the body-in-white (also known as the structural frame or body) are recognized. Once the component/system has been identified, computer aided design (CAD) information (e.g., information and/or symbols associated with the mechanical joints) is aligned/scaled and rendered on corresponding identified physical model components. The application of the disclosed techniques applies to many different contexts of manufacturing. For example, the AR device can be used to map the quality of a coating on an automotive part such as determining the thickness of an e-coating on a vehicle body and identifying problem areas that are difficult to coat. In some embodiments, the AR device is used to map out a factory floor and to identify the precise location and orientation robots should be installed at to build out an assembly line. The robots are positioned based on the AR device such that the installed robots will not interfere with each other or other obstructions in the environment.

In some embodiments, an augmented reality (AR) application is implemented by obtaining an image. For example, an image of an object of interest is captured using a camera from a smartphone, using AR smart glasses, etc. A model of the image is generated based on the hues of the image. For example, the image may be pre-processed to remove distortion, blur, etc. In some embodiments, image signal processing to correct the captured image is performed. The hue component of the image is extracted and points of the image are identified and used to generate a model of the object of interest. In some embodiments, a reduced model associated with a manufactured item is received, wherein the reduced model associated with the manufactured item has been generated by reducing an original model associated with the manufactured item. For example, the object of interest is a manufactured item such as an automotive part. A reduced model of the manufactured item may be retrieved from a data store that contains one or more models of different manufactured items. The reduced model is created by reducing an original model such as a computer aided design (CAD) model of the manufactured item. In some embodiments, an attempt is made to match at least a portion of the reduced model with the model of the image. For example, the model created from the image captured by the AR device is matched to the reduced model of the manufactured item. Once matched, data corresponding to the manufactured model and identified features can be displayed on or using the AR device. The user can further interact with the object of interest via the AR device.

In some embodiments, an image of a physical environment is obtained. For example, an image of a group of assembled parts is captured using an AR device. At least a portion of an object detected in the obtained image is identified. For example a particular part, such as the right hand front shock tower is detected in the obtained image. Using the image, a deviance from a reference property associated with the detected object is detected. For example, a marked location for a spot weld on the detected object, the right hand front shock tower, is identified and compared to a reference (and expected) location for the weld. The amount the actual location deviates from the expected location is determined and associated with the spot weld location. In some embodiments, information associated with the deviance is provided via an AR device. For example, a user interface component displays the amount the spot weld location deviates from the expected location on the AR device. In some embodiments, the expected spot weld location is represented as a sphere and the area within the sphere represents locations within the allowed tolerance. In the event the weld is outside the overlaid sphere, the marked spot weld location is outside the acceptable tolerances. In the event the marked location is inside the overlaid sphere, the marked location is within the allowed tolerances for manufacturing. In various embodiment, different user interfaces exist for displaying the information associated with the deviance from a reference property on the AR device.

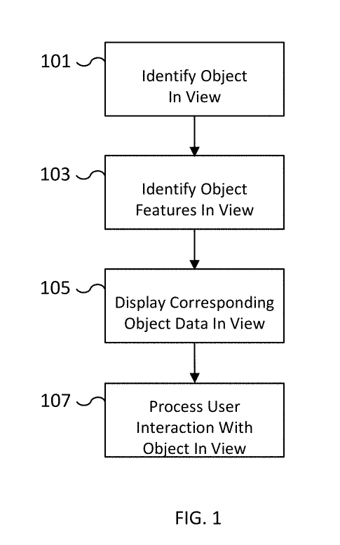

FIG. 1 is a flow diagram illustrating an embodiment of a process for applying augmented reality to manufacturing tasks. In some embodiments, the process of FIG. 1 is used to program robots for manufacturing including marking and/or programming the location of welds, holes, fasteners, or other mechanical joints, etc. In some embodiments, the process is used to inspect the accuracy of assembly including determining whether joints are assembled within tolerances and for performing dimensional quality inspection. In some embodiments, the process is used to determine the presence and/or thickness of a coating process. For example, the process may be used to analyze coated parts and to identify any portions of a part that are not sufficiently coated. In some embodiments, the process is used to distinguish between coated surfaces and raw metal. In some embodiments, the coating in an e-coating process uses electrodeposition, electrophoretic, electro-deposit, electrocoating, or another similar coating process. One benefit of the process of FIG. 1 is that the visual inspection of e-coated surfaces can be difficult when the surface is saturated with light, which is a typically required for the visual inspection of interior cavities. In some embodiments, the missing e-coated portions of a part are determined and displayed as an overlay on a model of the part being inspected. In some embodiments, the results of surface detection are used to determine common locations where a coating process is insufficient and/or needs improvement. Instead of requiring the vehicle to be disassembled, a vehicle can be analyzed by inspecting the surface, including interior cavity surfaces using a non-destructive tool such as a borescope, to create reference samples of the current e-coating process. The reference samples can be used to recalibrate the coating processes to entire complete coatings of all surfaces. For example, the process may be used to collect samples of coated parts to calibrate a coating process to ensure complete coverage when the coating process is performed. In some embodiments, the AR device includes more than one camera. A first camera can be used to determine the object in view and a second camera, such as a borescope, can be used to examine interior cavities that can not be easily visually inspected. In various embodiments, the process may be used to install robots in a factory. For example, using the process of FIG. 1, in some embodiments, the installation and/or alignment of robots can be calibrated with an accuracy measured in inches and in some scenarios in millimeters. In the various embodiments, the process of FIG. 1 improves the efficiency of manufacturing by significantly decreasing the time required to perform the task. In some embodiments, the process of FIG. 1 is used to create a database of quality inspection results, such as images of common defects or assembly errors, which can be used to improve the assembly and manufacturing process.

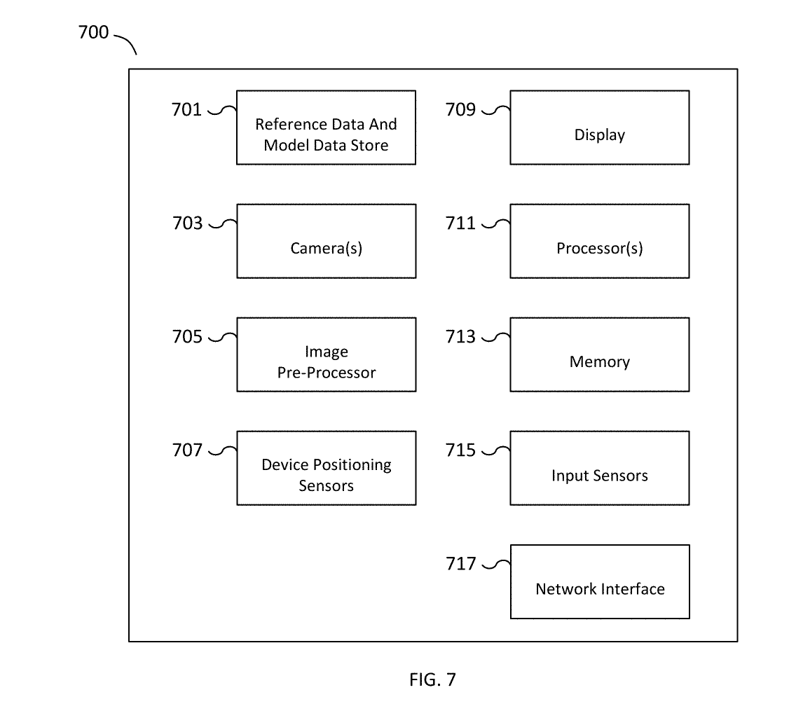

In some embodiments, the process of FIG. 1 is utilized with an augmented reality (AR) device such as a smartphone with a camera and position sensors such as gyroscopes and accelerometers. In some embodiments, the AR device is a pair AR smart glasses that have a camera and applicable sensors. For example, the AR device may be a pair of smart safety glasses equipped with AR functionality and hardware such as a camera and position sensors. In various embodiments, the AR device includes a display, such as a smartphone screen or the lenses of a pair of AR glasses that also function as displays. The AR device displays an object of interest as captured by a camera and overlays corresponding data of the object using the display. In some embodiments, the object of interest is viewed through a pair of AR glasses and the display overlays data (e.g., projects the relevant data) related to the view onto the lenses of the AR glasses. In various embodiments, the AR device includes a user interface for interacting with objects of interest. In some embodiments, components of the AR device are described with respect to FIG. 7.

At 101, an object in view is identified. For example, an object is viewed using an augmented reality (AR) device such as a smartphone or a pair of AR glasses. Typically, a camera of the AR device is pointed at the object of interest and a view of the object is displayed on the device. As an example, a smartphone camera is pointed at the object in the view of the camera and a live view of the object is displayed on the smartphone's display. Similarly, a user can view the object of interest using a pair of AR smart glasses by looking at the object. In some embodiments, a camera affixed to the AR glasses captures the view of the user. The user is able to view the object of interest through lenses of the AR glasses. In various embodiments, the object in the view is identified. For example, the object is identified as a particular automotive part such as a right hand front shock tower. As additional examples, the object is identified as an assembled left rear rail, a factory floor, or an automotive part for e-coating. In some embodiments, the object of interest in the view is identified using computer vision techniques such as mapping the object into a model and comparing the model with a database of reference models. For example, a database of reference models may be created from computer aided design (CAD) models and used to compare with the object in view to identify the object. In some embodiments, the reference model is a reduced model of an original CAD model of the object in view. In some embodiments, the object is identified using a user interface. For example, a user selects from a user interface element, such as a list of reference automotive parts, the identity of the object. As another example, the automotive part may be identified using voice actions. For example, the user of the AR device speaks a name identifying the automotive part to select the type of object in view. In various embodiments, other appropriate techniques may be used to identify the part such as programming the AR device for the part of interest. In some embodiments, a reference tag such as a QR Code or a 3D reference tag may be attached to the object to identify the part.

At 103, features of the object in view are identified. For example, features of the object are identified from the object in view. Features may include welds, holes, fasteners, joint locations, etc. In some embodiments, features include the precise location to install one or more robots on a factory floor. For example, features of the factory floor include the orientations and XYZ position to install a set of robots to create a manufacturing assembly line. In some embodiments, the features include the surface areas of the automotive part that is to be or has been coated.

At 105, data corresponding to the object in view is displayed. For example, data corresponding to mechanical joints are overlaid on the view of the object. As an example, for spot welds, the reference location of the spot weld is identified on the object in view and a user interface component is overlaid on the reference location. In some embodiments, the user interface includes a sphere identifying in 3D space the center of the expected spot weld. The volume of the spheres may be used to represent the allowable tolerance for the locations. For example, a larger sphere represents a larger tolerance and a smaller sphere represents a smaller tolerance. By comparing an actual spot weld to the overlaid user interface component representing the reference location of the spot weld, the user of the device can visually inspect the quality of a spot weld. In some scenarios, the mechanical joints such as spot welds are created by robots and the AR device displays data corresponding to the results of the work completed by the robots. In some embodiments, a user interface component is rendered by augmented at least a portion of one or more images of the camera view.

In various embodiments, different forms of data corresponding to the view are displayed. For example, the data may include the thickness of e-coating or where the e-coating process missed portions of the part and are still raw metal. In some embodiments, the thickness of the e-coating is represented by the color overlaid over the object in view. In some embodiments, the thickness of the e-coating is represented by a thickness of an outline or a contour over the object in view. In some embodiments, a surface that is coated is one visual representation and a raw metal surface is represented differently (e.g., using a different color, shading, etc.). In some embodiments, the data includes an XYZ-location and orientation for installing a machine such as an assembly robot. Different user interface components may display different forms of data such as the accuracy of the features, the relative order of the features, a numeric assessment related to a quality component of the feature, an identifier for the feature, etc. For example, in some embodiments, the feature such as an assembly or weld is ranked and the ranking is displayed using a user interface component. In some embodiments, defects are identified and categorized. The particular type of defect (e.g., missing weld, misplaced weld, correctly placed laser weld, etc.) may be displayed as the data corresponding to the object in view. In some embodiments, metrics such as inventory data and manufacturing metrics are accessible and displayed using the user interface.

At 107, user interaction with the object in view is processed. For example, using the AR device, the user may interact with the object in view including moving around the object and/or manipulating the data corresponding to the object. In various embodiments, as the user moves around the object in view, the data displayed on top of the view of the object changes to match the movement of the user. In some embodiments, the AR device includes a borescope camera used to inspect interior surface cavities. As the borescope is manipulated to change the image captured by the borescope's camera, the view of the object and the data overlaid on the view changes accordingly. In some embodiments, the borescope is an independently moveable camera attached to a smartphone AR device. For example, the borescope can function as an additional second camera in addition to a camera of the smartphone AR device for inspecting interior cavities or regions hard to access.

In some embodiments, the user interaction includes relying on the data to mark a part for assembly. For example, using the object view, a user can mark a part for assembly and confirm the precision of the marking via the user interface of the AR device. As another example, the data can be used to program a robot. For example, features matching mechanical joints are selected by the user via the user interface and the data associated with selected mechanical joints (e.g., the locations, tolerances, order of in the sequence of assembly, etc.) is provided to a robot for programming. As yet another example, a user can interact with the user interface to inspect a part or assembly. For example, certain mechanical joints may be selected via the user interface and marked as non-acceptable if they are not within the acceptable tolerances. The marked features may also be exported and used to re-calibrate robots used to perform the operation by adjusting for any identified deviations.

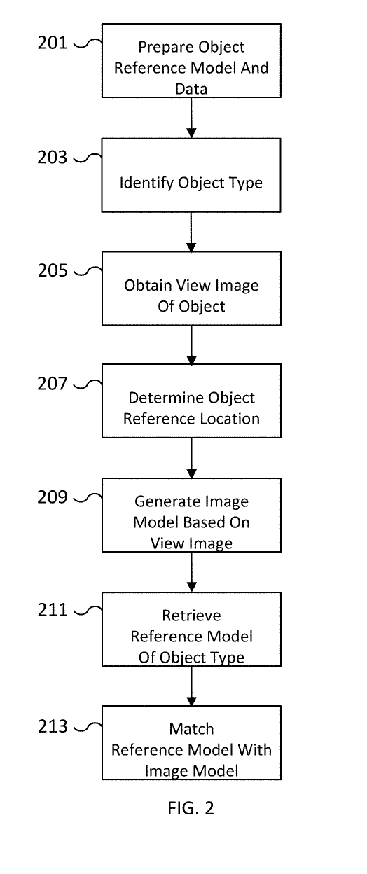

FIG. 2 is a flow diagram illustrating an embodiment of a process for matching an object of interest to a reference model. In some embodiments, the process of FIG. 2 is used by an augmented reality (AR) device to match an object of interest in the view of the AR device to a reference model for displaying data corresponding to the model and identified features of the object. In some embodiments, the process is used to improve the efficiency of manufacturing such as speeding up the time required to program robots for an assembly line and to inspect part components or assembled parts components. In some embodiments, the process of FIG. 2 is used to mark a part to teach and/or program a joint robot. In some embodiments, the process is used for dimensional quality inspection of physical joints. In various embodiments, the steps of FIG. 2 are performed at 101 of FIG. 1 to identify an object of interest in the view of an AR device.

At 201, an object reference model and corresponding data of the model are prepared. For example, a computer aided design (CAD) model of an object, such as an automotive part or a robot is used to create a reference model. In some embodiments, the reference model is a reduced version of the CAD model. For example, a reference model may only include the exterior surfaces of the CAD model. By eliminating the interior volume of the model, a reference model is reduced in size and complexity but may still function as a reference to match an object of interest. In some embodiments, one or more thickness parameters are exported and associated with the reduced model as simplified metrics for the part's interior volume. In various embodiments, corresponding data of the model is prepared and used to overlay over the object when viewed. The data may include data of certain features of the reference model such as mechanical joints, holes, interfaces with other parts, etc. In some embodiments, the data includes tolerances associated with the features such as the tolerance allowed for a weld to be considered acceptable. In some embodiments, the data includes cumulative requirements for assembly such as the number of required welds for a part, the number of acceptable deviations across all mechanical joints, a deviance from a reference property, etc. In various embodiments, the data is used to create a user interface for the AR device such as depicting the location of reference features, the tolerances associated with the features, an appropriate order in the sequence of assembly, manufacturing metrics, etc. In various embodiments, the object reference model and corresponding data are stored in a data store such as a database or a server backing store. In some embodiments, the reference data (e.g., model and corresponding data) is stored in the augmented reality (AR) application and/or on the AR device.

At 203, an object type is identified. For example, the type of the object of interest is identified. In some embodiments, the object type is the part type of an automotive part such as a right hand front shock tower used for a particular vehicle. In some embodiments, the object type is a body frame of a vehicle. In various embodiments, the object type is identified. In some embodiments, the type is identified by the user via a user interface. For example, a list of potential types is presented on a display and the user selects the correct object type associated with the object of interest. In some embodiments, the selection is performed using a voice command such as by speaking the name of the part. In some embodiments, the object type is identified by scanning a reference marker such as a QR code, a sticker, a 3D marker, a radio-frequency identification (RFID) tag, or other identifying tag. In some embodiments, the augmented reality (AR) device is pre-configured or programmed with the particular object type. For example, at a particular assembly station, the AR device associated with the station is programmed for the part dedicated at that station. In some embodiments, the object type is determined using machine vision techniques such as using machine learning to match an image of the object of interest to an object type. Other vision techniques such as creating a model of the image (as discussed in more detail herein) and matching the image to reference models may also be utilized. In various embodiments, the object type is associated with a reference model and reference data prepared at 201.

At 205, a view image of an object is obtained. For example, a camera sensor of an augmented reality (AR) device is pointed at an object of interest. In some embodiments, the camera is part of a pair of AR smart glasses or a smartphone. In various embodiments, the camera captures a view image of the object. For example, a view of the camera is used to capture an image (i.e., the view image) of the object. As another example, a user points a smartphone at an automotive part and the AR device captures a view image of the object. In various embodiments, the view image is an image associated with a view from the perspective of the camera of the AR device. In some embodiments, the view image is pre-processed using image processing techniques such as image correction. For example, image correction techniques such as de-blurring, sharpening, alignment, distortion correction, and/or projections, etc. may performed to enhance the view image.

At 207, an object reference location is determined. For example, a reference location of the object of interest is determined. In various embodiments, an object of interest can be positioned in many different orientations. One or more reference locations are used to determine the XYZ-position and orientation of the object. In some embodiments, a reference location may be a reference marker, such as a sticker or 3D marker, placed on the object. For example, a 3D marker can be created using a 3D printer. In some scenarios, a 3D printed marker is printed with a height of approximately ¾ inches and can be attached and later removed from an object of interest and reused on a different object. In various embodiments, the marker is positioned based on locating features. In some embodiments, the locating features are locations of the object with repeatable tight tolerances. For example, a mounting hole with a location that is a tight tolerance can be a locating feature because it allows for a reliable reference location. The contours, shape, size, and/or color, among other properties of the 3D marker, can be used to differentiate one marker from another and also can be used as an anchor position to determine the orientation of the object. In some embodiments, the 3D marker is used to determine the distance of the object of interest from the camera. In various embodiments, a reference location may be utilized to determine the position in 3D space and orientation of the object of interest and the relative distance of the object from the AR device and/or camera. In some embodiments, object reference locations are part of the object such as seams, bends, joints, holes, etc. and are not auxiliary markers such as stickers or 3D markers that are attached to the object. In some embodiments, a particular entrance hole or access location for a part with an internal cavity is used as a reference location. For example, a part may have an internal cavity that is not visible from the outside of the part. One or more entrance holes or access locations to the interior of the part allow access to cavities of the part and can be used for inserting a tool such as a borescope for inspecting the interior of the part. In some embodiments, an entrance location such as an access panel or hole is a reference location and is automatically identified when a camera, such as a borescope camera, is placed near or in the entrance location. For example, using the images captured by the camera, the entrance hole is identified and used as an object reference location. In some embodiments, reference markers such as 3D markers may be utilized to identify the object type and also serve as reference locations. In some embodiments, reference markers are utilized as reference locations to speed up and reduce the computational resources associated with identifying a reference point of the object.

In some embodiments, the reference location is identified via a user interface. For example, an entrance hole into an interior cavity of a part may be identified via a user interface. Once identified, a camera can be inserted into the interior cavity via the entrance hole. Using the entrance hole, a difficult to reach region can be inspected for defects, such as coating misapplications. In some embodiments, a second camera, such as a borescope camera, is inserted into the entrance hole. In some embodiments, the camera is a flexible camera that can be manipulated around bends and turns. In various embodiments, the camera may be an independently moveable camera used in addition to a first camera for identifying the object of interest. In some embodiments, one or more cameras may be used together to identify the object of interest and both function together for detecting features of a manufactured item. For example, one camera is used for exterior surfaces and a second camera is used for interior cavities or difficult to access surfaces.

At 209, an image model based on the view image is generated. For example, a model of the object of interest is generated based on a view image of the object obtained at 205. In some embodiments, the model generated from one or more images is an image model. In some embodiments, the model is a collection of points corresponding to the exterior surface (or visible surface) of the object of interest. For example, the view image of an object is analyzed to determine a collection of points that are part of the surface of the object. The points are analyzed to determine their 3D positions. The points are collected together to create a 3D model of the object in the view image. In some embodiments, the model is a collection of points with XYZ coordinates. In some embodiments, the model is a mesh created from the collection of points. In various embodiments, the positions of points are determined using the relative position of the AR device (e.g., the camera) and the view image. In some embodiments, one or more reference locations are used to create the image model. For example, a reference location can be used to determine the distance between two or more points based on the distance between reference locations and/or the size of a reference location from the perspective of the camera. In various embodiments, the image model is a collection of surface points corresponding to the object of interest. In some embodiments, a minimum number of points is required to match the image model with a reference model.

At 211, a reference model of the object type is retrieved. For example, based on the object type identified at 203, a reference model corresponding to the object type is retrieved. In some embodiments, the reference model is retrieved from memory storage of the augmented reality (AR) device. In some embodiments, the reference model is stored in a data store such as a database. In various embodiments, the reference model may be stored remotely from the AR device and retrieved via a network connection of the AR device.

At 213, a reference model and image model are matched. For example, an image model of the right hand front shock tower of a vehicle as viewed through an augmented reality (AR) device is matched to the reference model of the part. In various embodiments, the match includes confirming the object in view is the object type and aligning the position, orientation, and scale of the image model to the reference model. For example, the image model as viewed from the perspective of the camera is matched to the reference model as viewed from the same perspective. In various embodiments, a reference coordinate system is used to translate between the reference model and the image model. In some embodiments, the reference model and the image model are matched by determining whether the surface points collected for the image model at 209 match with the reference model. For example, the 3D position of each surface point is compared to the surface of the reference model and a point is determined to exist on the surface of the reference model if the point is within a certain tolerance. For example, in some embodiments, a point is considered on the surface if it is within a tolerance (e.g., 0.001 mm) of the surface described by a surface equation. In some embodiments, a thickness parameter is used to determine if the point lies on the reference model. For example, a thickness parameter may be used to determine if a point is within a certain threshold of the surface. In some embodiments, a threshold number of surface points must fit to the surface of the reference model for the image model to match the reference model.

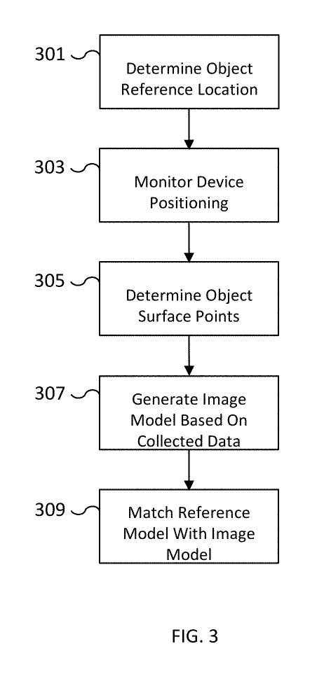

FIG. 3 is a flow diagram illustrating an embodiment of a process for matching an object of interest to a reference model. In some embodiments, the process of FIG. 3 is used by an augmented reality (AR) device to match an object of interest in the view of the AR device to a reference model for displaying data corresponding to the model and identified features of the object. In some embodiments, the process is used to improve the efficiency of manufacturing such as speeding up the time required to program robots for an assembly line or to inspect part components or assembled parts components. In some embodiments, the step 301 is performed at 207 of FIG. 2; the steps 303, 305, and/or 307 are performed at 209 of FIG. 2; and/or the step 309 is performed at 211 and/or 213 of FIG. 2. In various embodiments, the process of FIG. 3 is performed using an AR device as described with respect to FIG. 1.

At 301, an object reference location is determined. In various embodiments, the object reference location is determined as described with respect to step 207 of FIG. 2. In some embodiments, the object reference location is based on one or more of the object's features or one or more reference markers affixed to the object.

At 303, the positioning of the device is monitored. For example, using sensors of the augmented reality (AR) device such as gyroscopes and accelerometers, an XYZ location and an orientation of the device is determined. In various embodiments, as the device moves, its positioning is monitored and the deviations from past positions are tracked. In some embodiments, the orientation corresponds to the direction of the camera view. In some embodiments, the XYZ location is the 3D position of the device. In some embodiments, the XYZ location is a relative location of the device with respect to the object(s) in the camera view. In various embodiments, a position-location system such as the Global Positioning System (GPS) or other positioning system is utilized. In various embodiments, the position or positioning includes not only an XYZ location (absolute or relative) but also an orientation.

At 305, surface points of the object are determined. For example, the object of interest in the camera view is analyzed for surface points. In some embodiments, surface points of the object are determined using visual odometry techniques. For example, using multiple cameras or multiple images, the pose of the object of interest is determined. In some embodiments, the location and orientation of the object of interest are determined. In some embodiments, the relative location and orientation of the object of interest are determined with respect to the camera of the augmented reality (AR) device.

In some embodiments, a surface point is determined based on the features of the object of interest. In various embodiments, the same surface point is analyzed from different perspectives such as from two different cameras or via two different images once the camera has moved. In some embodiments, features are matched across two corresponding images and 3D coordinates of the surface points are determined. In some embodiments, the 3D coordinates are determined by triangulating corresponding surface points of different matched images. In various embodiments, multiple readings of the same point are utilized.

In some embodiments, light transitions are used to identify surface points. For example, a lighting value associated with a location on the object is associated with a depth. In some embodiments, the light value is determined by first processing the image to extract light values. For example, in some scenarios, a color representation of an image is converted to extract a hue value.

In some embodiments, a depth sensor is used to collect additional information from surface points. For example, a depth sensor collects distance information for each surface point from the camera. The distance information may be utilized to determine the 3D position of a surface point. In some embodiments, the depth information is used in connection with the techniques described above to increase the accuracy of a collection of surface point data.

At 307, an image model is generated based on the collected data. For example, the collected data includes a sufficient set of surface points associated with the object of interest and a model representing the object of interest is generated. In various embodiments, a threshold number of surface points are required to correctly model the object. For example, in some certain scenarios, a threshold number of surface points on the order of thousands of points are required for each object of interest. In various embodiments, the model of the object of interest generated is an image model.

At 309, the reference model and image model are matched. For example, the reference model and image model are matched as described with respect to step 213 of FIG. 2. In various embodiments, the surface points of the model generated at 307 are tested to determine whether they fit to the surface of the reference model. In some embodiments, the reference model is a geometric representation such as a surface equation. A surface point fits the surface of the reference model by evaluating the surface equation with the 3D position of the surface point. In various embodiments, a threshold number of surface points must fit the reference model to match the image model with the reference model. For example, in some scenarios, the computation and battery power of the augmented reality (AR) device is limited so a threshold of less than 100 percent of matching points is utilized to conserve resources.

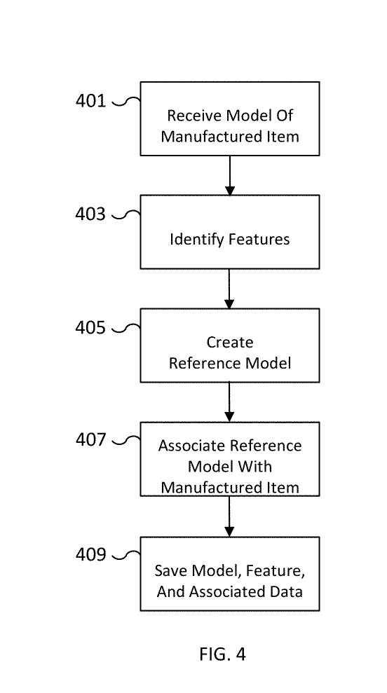

FIG. 4 is a flow diagram illustrating an embodiment of a process for preparing reference data for an augmented reality manufacturing application. In some embodiments, the process of FIG. 4 is used to prepare reference models and corresponding data and features of the reference models for the augmented reality techniques described with respect to FIGS. 1-3, 5, and 6. For example, a reference model representing the surface of an automotive part is created using the process of FIG. 4 along with features identifying mechanical joints such as welds and rivets. Overlay data including tolerances as well as user interface information such as the visual indicators including colors, size, shape, etc. may be included as well. As another example, relationship data between the different features such as the order of laser welds that should be performed, the order holes should be punched, etc. are prepared using the process of FIG. 4. In some embodiments, the process of FIG. 4 is performed on a backend server in advance of using the augmented reality techniques described with respect to FIGS. 1-3, 5, and 6.

At 401, a model of the manufactured item is received. In some embodiments, a computer aided design (CAD) model of a manufactured item is received. For example, a CAD model of a right hand front shock tower of a vehicle is received. In various embodiments, the model is an original model of the manufactured item. In some embodiments, the CAD model is a three-dimensional shape with one or more solid interior regions. For example, the CAD model of a body frame includes solid metal regions. In various embodiments, the solid regions of the CAD model correspond to interior points of the manufactured item.

At 403, features of the model are identified. In some embodiments, the features of the model include mechanical joints, fasteners, holes, entrance holes, access panels, etc. In some embodiments, the features include reference locations of the model. In some embodiments, the features include the interface between the model and other parts. In various embodiments, the features include locations in a factory for installing a manufacturing robot. In various embodiments, the features are identified from data included in the computer aided design (CAD) model of the manufactured item. In some embodiments, the features are identified using computer vision and/or machine learning techniques.

At 405, a reference model is created. In some embodiments, a reference model is a reduced version of the model received at 401. For example, in some embodiments, a reference model contains only the exterior or visible surfaces of the manufactured item. For example, interior points are removed in the reference model. By reducing the model to only surfaces and excluding the interior volume of the model, the computational requirements for determining whether a location fits the surface of the model are reduced. In some embodiments, the reference model is a geometric representation such as one or more surface equations. A point on the surface of the reference model is a solution to the surface equation(s) of the reference model. In various embodiments, the surface equations define the surface of a hollow version of the original model. In some embodiments, interior points of the model are not solutions to the surface equations. In some embodiments, the interior points corresponding to solid interior regions are removed from the original model to create the reference model. In some embodiments, solid interior regions are instead approximated with a thickness parameter. For example, a reference model may include one or more surface equations and one or more thickness parameters to describe the surface of a manufactured item and a corresponding thickness of the surface of the item to approximate solid interior regions.

At 407, the reference model is associated with a manufactured item. For example, when the manufactured item is the object of interest, the reference model is utilized for analyzing the object of interest. In some embodiments, each reference model has a unique identifier to associate it with the manufactured item. In some embodiments, the reference models for manufactured items are stored in a data store and each have an associated identifier, such as the part name or number.

At 409, the reference model, features of the reference model, and data associated with the model are saved. For example, reference data that includes the reference model, features of the model, and data associated with the reference model is stored in a data store. In some embodiments, the data includes data for instantiating a user interface for an augmented reality (AR) device. In some embodiments, the user interface data includes the data used to render the user interface component for a detected feature such as the color, shape, size, enable state functionality, disabled state functionality, descriptions, etc. For example, the data describes the functionality to execute, the size and color to render a visual indicator, and a description to display when a detected feature is selected (e.g., an enable state is true). As another example, when a detected feature is selected, the color can change as configured by the user interface data. As another example, the size of the visual indicator can expand to display descriptive information on the detected feature such as an identifier or label. The descriptions may include information on the location of the feature, the type of feature (e.g., spot weld, rivet, etc.), the acceptable tolerances of the feature, etc. In some embodiments, reference markers such as 3D markers, entrance holes, access panels, etc. are stored as reference data. In some embodiments, feature parameters including tolerances, acceptable deviations from a reference property, and the appropriate thickness for particular coatings, etc. are stored as reference data. In various embodiments, the reference data is utilized by the user interface of the AR device for interacting with and manipulating an object of interest.

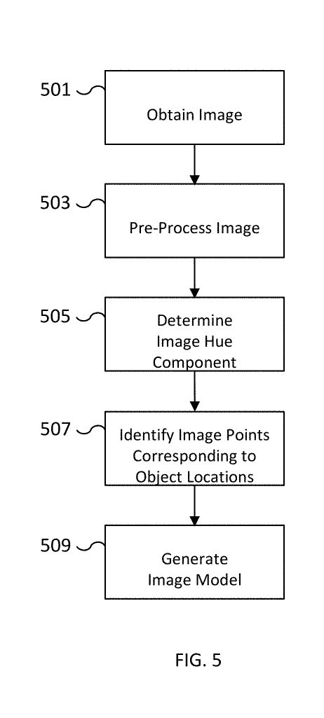

FIG. 5 is a flow diagram illustrating an embodiment of a process for applying augmented reality to manufacturing. In some embodiments, the process of FIG. 5 utilizes a hue component of the view image to generate an image model of an object of interest. In some embodiments, the process of FIG. 5 is performed using an augmented reality (AR) device such as the one described with respect to FIG. 1. In various embodiments, the hue component of a view image is utilized to determine the relative depth for different surface points of an object of interest from a camera. In some embodiments, the steps of FIG. 5 are performed at 101 of FIG. 1. In some embodiments, the steps 501, 503, and/or 505 are performed at 205 of FIG. 2 and the steps 507 and/or 509 are performed at 207 and/or 209 of FIG. 2. In some embodiments, the steps 507 and/or 509 are performed at 301, 303, 305, and/or 307 of FIG. 3.

At 501, an image is obtained. In some embodiments, an image is obtained as discussed with respect to 205 of FIG. 2. For example, an image is captured using a camera sensor. In some embodiments, the image is captured using a traditional color space such as containing red, green, and blue channels. In some embodiments, a different color space is utilized by the camera. In some embodiments, a high dynamic range camera is used. In some embodiments, two cameras, such as a stereo camera setup, are used to capture multiple images from slightly different perspectives. In various embodiments, multiple images are captured and utilized to determine the depth of an object of interest.

At 503, the image is pre-processed. For example, an image may be pre-processed using a processor such as an image signal processor, a graphics processing unit (GPU), a central processing unit (CPU), or other appropriate processor. In some embodiments, the pre-processing includes image correction techniques. For example, the pre-processing may include image correction techniques such as de-blurring, sharpening, alignment, distortion correction, and/or projections, etc. and may be performed to enhance the image prior to analysis.

At 505, an image hue component is determined. For example, an image is converted to extract hue components of the image. In various embodiments, the hue component of the image is used to determine the relative depth of surface points of the object. In some embodiments, the hue component is used to identify light contrast and is less sensitive to the amount of light compared to other image components. In various embodiments, the hue component is used to reduce the amount of light saturation on the object.

At 507, image points corresponding to object locations are identified. For example, using the hue component extracted at 505, image points corresponding to the surface of the object of interest are identified. In some embodiments, the depth is based on differences in light transitions from analyzing the hue value. For example, a hue value associated with an image point is used to determine a depth and 3D position of a point on the surface of the object. In some embodiments, the hue component is used to approximate depth by analyzing the contrast between neighboring hue values and associating a depth value based on the differences in hue values. In some embodiments, a hue value of a location is compared to neighboring hue values and a threshold value is determined based on the hue values. For example, in the event a location's hue value compared to neighboring hue values exceeds a threshold, the location's depth is assigned a different depth. Hue values whose differences do not exceed the threshold are assigned the same depth. In some embodiments, regions of similar hue values are assigned the same initial depth values. In some embodiments, a threshold value is used to identify a region of light contrast in the image. The model of the image is generated by determining whether a difference between neighboring hue values of the image exceeds a threshold value. In some embodiments, as additional image data is gathered, the accuracy of the depth values increases. The initially assigned depth values are approximate values and increase in accuracy with additional image data. In some embodiments, multiple images along with the relative location and orientation of the camera when the images are captured are required to determine a 3D position of an image point. For example, in some embodiments, surface points of the object and their 3D positions are determined by using visual odometry techniques applied to the hue component.

At 509, an image model is generated. For example, using the image points identified at 507, the points are collected to create an image model of the object of interest. In some embodiments, the image points are surface points used to generate an image model as described with respect to 209 of FIG. 2 and/or 307 of FIG. 3. For example, a threshold number of image points are collected, sufficient to match an image model to a reference model. In some certain scenarios, a threshold number of surface points on the order of thousands of points are required for each object of interest. In various embodiments, the number of points is dependent on the complexity of the image, the number of reference models, and/or the complexity and similarity between reference models. For example, in the event there are many similarly shaped reference models, the number of image points required is increased.

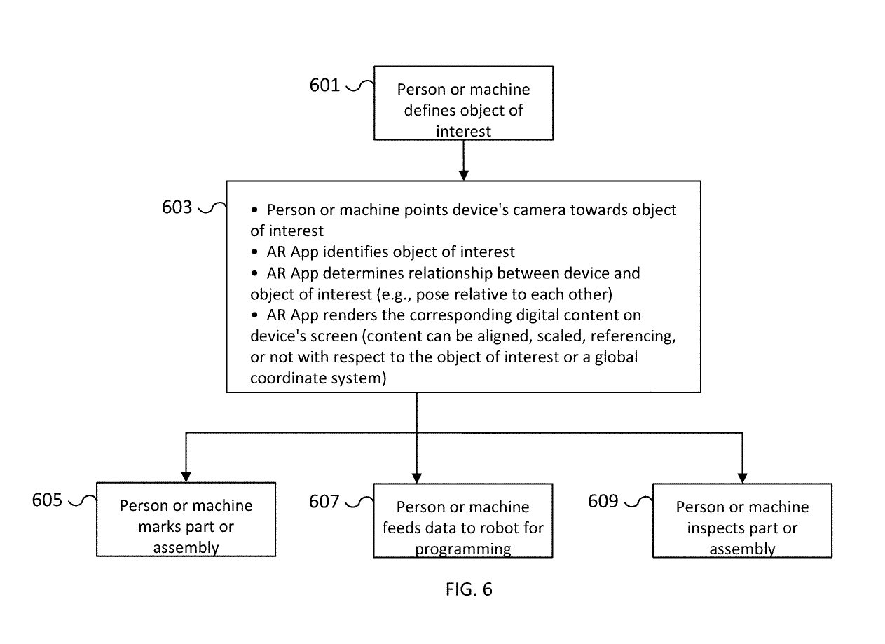

FIG. 6 is a flow diagram illustrating an embodiment of a process for applying augmented reality to manufacturing. In some embodiments, the process of FIG. 6 is performed using an augmented reality (AR) device discussed with respect to FIG. 1. In some embodiments, the step 601 is performed at 101 of FIG. 1; the step 603 is performed at 101, 103, 105, and/or 107 of FIG. 1; and/or the steps 605, 607, and/or 609 are performed at 107 of FIG. 1.

At 601, a person or machine defines an object of interest. For example, an object of interest, such as a certain automotive part, an entrance hole into an automotive body cavity, a factory floor layout, etc. is selected from a set of potential objects and/or features.

At 603, a person or machine points a device's camera towards an object of interest. In some embodiments, an augmented reality (AR) application identifies the object of interest. The AR application determines the relationship between the AR device and the object of interest (e.g., identifying the pose of the AR device relative to the object of interest). The AR application renders the corresponding digital content on the AR device's screen. For example, the content can be aligned, scaled, referencing, or not with respect of the object of interest or a global coordinate system. In various embodiments, the AR device overlays corresponding digital content based on the object identified in the view of the device's camera. Once the digital content, such as data corresponding to features related to the object of interest, is presented, processing can proceed to one or more of 605, 607, and/or 609.

At 605, a person or machine marks the assembly. For example, a machine uses the information of the AR device to mark the location of mechanical joints. As another example, a user uses the information of the AR device to mark the location for spot welds, holes, etc. on the part of interest.

At 607, a person or machine feeds the data to a robot for programming. Using the information presented at 603, the information is used to program a robot for performing assembly operations such as laser welds, rivets, seals, etc. In some embodiments, the information is used to re-calibrate a robot based on detected deviations from a reference property.

At 609, a person or machine inspects a part or assembly. For example, using the information from 603, a part or assembly is inspected for quality assurance or fit and finish. In some embodiments, the quality of the assembly is reflected by the user interface. For example, mechanical joints that are not acceptable are displayed with an overlay in one color and mechanical joints that are acceptable are displayed with an overlay in a different color.

FIG. 7 is a block diagram illustrating an embodiment of an augmented reality system for manufacturing. In various embodiments, the processes of FIGS. 1-6 utilize an augmented reality (AR) system such as the one described in FIG. 7. For example, an AR device such as a smartphone or AR smart glasses may be used to implement the AR techniques described herein by including at least the components of FIG. 7. In some embodiments, the components of FIG. 7 are part of an AR device that includes a client device, such as a smartphone or a pair of AR smart glasses, and a backend component such as a backend server. For example, certain portions of the processes of FIGS. 1-6 may be implemented on a backend server whereas other portions are implemented on the client AR device. The division of tasks and/or components between the client device and backend server takes into account the mobility of the device, the power consumption required for performing the processes, the amount of data required, the weight of the client device, and the computational power of the client device, among other factors. In the example shown, AR system 700 includes reference data and model data store 701, camera(s) 703, image pre-processor 705, device positioning sensors 707, display 709, processor(s) 711, memory 713, input sensors 715, and network interface 717. In various embodiments, the components of FIG. 7 are communicatively connected using a bus or similar interface (not shown). For example, processor(s) 711 can communicate with memory 713 and display 709 via a communication bus. In various embodiments, one or more buses (not shown) may provide access to the components of FIG. 7 as well as to additional subsystems or components that are not shown in FIG. 7.

In some embodiments, reference data and model data store 701 is digital storage for reference data associated with potential objects of interest. The reference data may include reference models, data for displaying on the augmented reality (AR) user interface, feature data, etc. In some embodiments, reference data and model data store 701 exists on a backend server, the client device, or both. For example, a complete set of reference data may exist on a backend server and a cached subset of reference data may be stored on a client AR device. In some embodiments, reference data and model data store 701 is a reference data store for retrieving reference data of detected features for rendering user interface components.

In some embodiments, camera(s) 703 are one or more camera sensors for capturing view images of objects of interest. In some embodiments, multiple cameras are arranged in a stereo camera setup. In some embodiments, only a single camera is used. For example, multiple images are captured from a single camera along with the camera's positional state (e.g., the camera's position and orientation).

In some embodiments, two or more independent cameras are used for performing the processes discussed herein. For example, a smartphone AR device camera is used for identifying a manufactured item and matching a reference model to the observed object. A second camera, such as a borescope camera, is used to inspect difficult to reach areas of the object, such as internal cavities. The second camera may be independently moveable with respect to the first camera. In some embodiments, an exterior camera may be used to inspect easy to reach areas and an independently moveable camera is used to inspect hard to reach areas. In various embodiments, the different views of the cameras are accessible via the AR device. For example, a smartphone AR device has two cameras, a non-moveable camera and a flexible camera for inspecting interior regions.

In some embodiments, image pre-processor 705 is an image processor for pre-processing captured images of camera(s) 703. For example, image pre-processor 705 may be used for image correction and hue extraction. In some embodiments, image pre-processor 705 is one of processor(s) 711. In some embodiments, image pre-processor 705 is a dedicated processor used for image signal processing. In some embodiments, image pre-processor 705 may be part of the camera hardware of camera(s) 703.

In some embodiments, device positioning sensors 707 are sensors attached to the AR device used to determine the 3D position and orientation of the camera. In some embodiments, the 3D position and/or orientation is relative to the object of interest captured by the camera. In various embodiments, device positioning sensors 707 may include accelerometers and/or gyroscopes. In some embodiments, device positioning sensors 707 include a position-location system such as the Global Positioning System (GPS) or other positioning system.

In some embodiments, display 709 is a display for presenting an AR user interface. In some embodiments, the display is a touchscreen display of a smartphone. In some embodiments, the display includes the lenses of an AR device. In some embodiments, the display includes a projection component for projecting a user interface over the visual image captured by camera(s) 703. In some embodiments, the display can be used to toggle between different camera views, such as different views of the different cameras of camera(s) 703. In some embodiments, an additional display (not shown) is used for viewing multiple camera views simultaneously.

In some embodiments, processor(s) 711 are one or more processors for performing the processes of FIGS. 1-6. In some embodiments, one or more of the processors of processor(s) 711 is a dedicated augmented reality (AR) processor that is optimized for AR operations such as mathematical transformation operations. In some embodiments, processor(s) 711 may include a central processing unit (CPU), a graphical processing unit (GPU), and/or other microprocessor subsystem. In various embodiments, one or more processors of processor(s) 711 read processing instructions from a memory, such as memory 713, for performing the processes of FIGS. 1-6.

In some embodiments, memory 713 can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor(s) 711. Also as is well known in the art, primary storage typically includes basic operating instructions, program code, data, and objects used by the processor(s) 711 and/or image pre-processor 705 to perform its functions (e.g., programmed instructions). In some embodiments, memory 713 includes remote memory (or storage) such as cloud storage or network storage. For example, remote memory may store program code, data, and objects used by the processor(s) 711 and/or image pre-processor 705 to perform its functions (e.g., programmed instructions). In some embodiments, AR system 700 executes an application stored remotely (e.g., on the cloud in remote memory) from a local AR device. In various embodiments, remote memory is accessed via network interface 717.

In some embodiments, input sensors 715 are used to capture user input and may be used by a user to manipulate the AR device. For example, in some embodiments, input sensors include a touch screen interface, tactile user interface components such as buttons, knobs, switches, slides, etc., one or more microphones, gesture sensors, controllers, etc. As an example, in some embodiments, input sensors 715 include one or more microphones for capturing voice commands. As yet another example, in some embodiments, input sensors 715 include a touch screen for selecting, manipulating, zooming, panning, etc. In some embodiments, input sensors 715 include dedicated buttons for zooming in, zooming out, and/or adjusting the camera's focus. In various embodiments, input sensors 715 are sensors for gathering user input or other input for the AR device.

In some embodiments, network interface 717 allows processor(s) 711 to be coupled to another computer, computer network, or telecommunications network using one or more network connections. For example, through the network interface 717, the processor(s) 711 can receive information (e.g., reference models, user interface data, data objects, or program instructions, etc.) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor(s) 711 can be used to connect augmented reality (AR) system 700 to an external network and transfer data according to standard protocols. For example, various process embodiments disclosed herein can be executed on processor(s) 711, or can be performed across a network such as the Internet, intranet networks, or local area networks, in conjunction with a remote processor that shares a portion of the processing. Additional mass storage devices (not shown) can also be connected to processor(s) 711 through network interface 717.

The augmented reality (AR) system shown in FIG. 7 is but an example of an AR system suitable for use with the various embodiments disclosed herein. Other AR systems suitable for such use can include additional or fewer subsystems. Other AR systems having different configurations of subsystems can also be utilized.

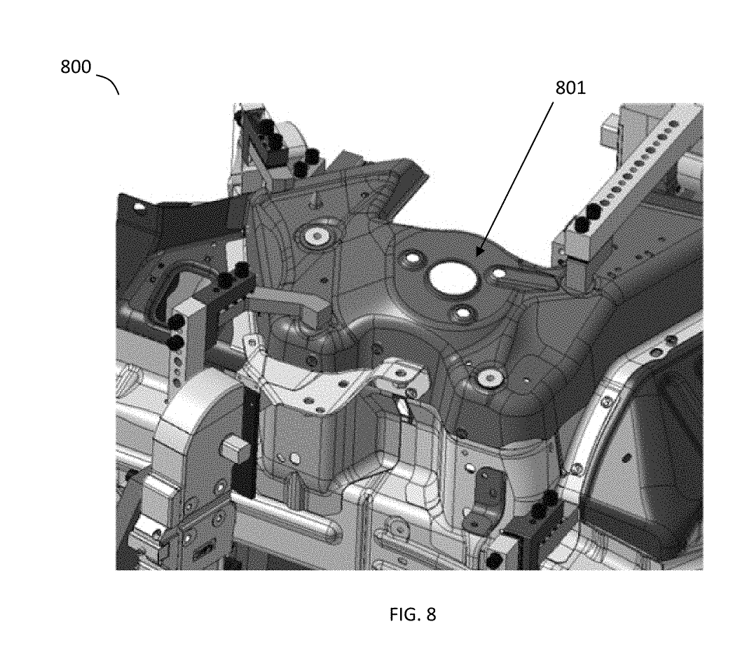

FIG. 8 is a diagram illustrating a model of assembled manufactured items for an embodiment of an augmented reality manufacturing application. In the example shown, model 800 is an original computer aided design (CAD) model of assembled automotive parts and includes right hand front shock tower model 801. In some embodiments, a reference model of the part corresponding to right hand front shock tower model 801 is created using right hand front shock tower model 801. For example, in some embodiments, a reference model is created by exporting only the surfaces of right hand front shock tower model 801. In some embodiments, the features of right hand front shock tower model 801 are extracted from the model and may include features such as holes, joints, seams, seals, etc. In various embodiments, model 800 and right hand front shock tower model 801 are high resolution models that contain additional information not found in the corresponding reference or reduced models.

In various embodiments, original models such as model 800 and/or right hand front shock tower model 801 may be accessible via the AR device. For example, in some embodiments, a user can select the original computer aided design (CAD) model from the AR device in addition to viewing overlaid data using a reduced model. As an example, a feature and/or part in the view of the AR device can be selected and an original or higher-resolution model may be loaded and displayed. In some embodiments, the original model is displayed above or alongside the manufactured part the user is inspecting. In some embodiments, the view of the original model can be manipulated such as zooming in, panning, and/or rotating the view of the model. Other interactions are possible as well, such as bringing up an exploded view or an interior view, retrieving data corresponding to the design of the part, etc. In various embodiments, the user of the AR device can perform a visual inspection using the original model with the actual manufactured part, for example, in the event the user desires to explore additional data related to the manufactured part that is not displayed as part of the overlaid feature data.

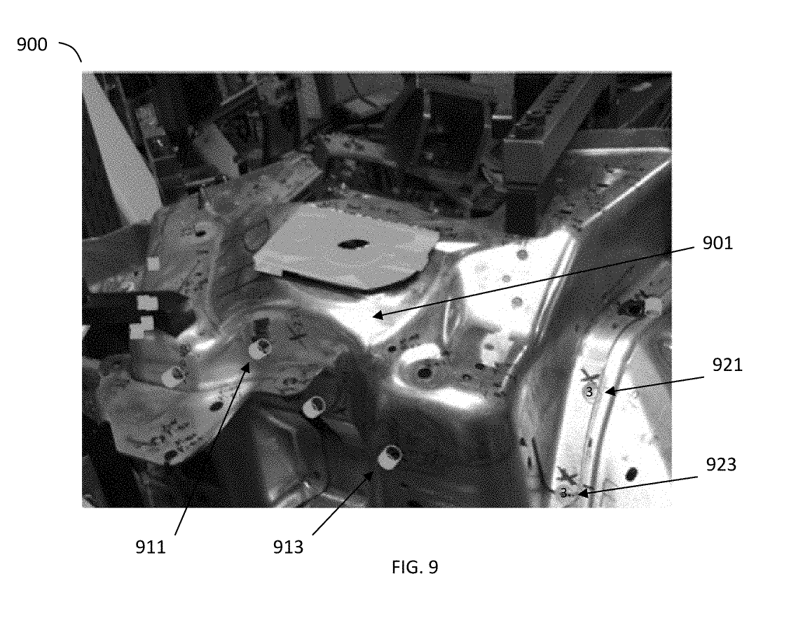

In some embodiments, model 800 and/or right hand front shock tower model 801 is used by the process of FIG. 4 to create a reference model of a manufactured item. In some embodiments, model 800 and/or right hand front shock tower model 801 is retrieved at 401 of FIG. 4 and surface data of the model is extracted to create a reference model. In various embodiments, the model 800 and/or right hand front shock tower model 801 is generated using a computer aided design (CAD) process and tools. In some embodiments, model 800 and/or right hand front shock tower model 801 is used to create the user interface of FIG. 9.

FIG. 9 is a diagram illustrating an embodiment of a user interface for an augmented reality manufacturing application. In some embodiments, the user interface of FIG. 9 is created using the processes of FIGS. 1-6 and/or using the augmented reality (AR) system of FIG. 7. In various embodiments, the user interface of FIG. 9 is a view seen by a user of an AR device using one or more of the processes of FIGS. 1-6 when pointing the AR device at an automotive part. In the example shown, the user interface 900 is a view of a manufactured item with corresponding relevant data overlaid on the item. User interface 900 includes object of interest 901 and feature user interface components 911, 913, 921, and 923.

In some embodiments, user interface 900 includes a digital representation of mechanical joints and other relevant information associated with an object of interest. In the example shown, object of interest 901 is the right hand front shock tower of a vehicle during assembly and manufacturing. User interface components 911, 913, 921, and 923 are overlaid on object of interest 901. In some embodiments, user interface components 911, 913, 921, and 923 are displayed by augmenting at least a portion of one or more images captured by a camera of the AR device. For example, the current image corresponding to the camera view of object of interest 901 is augmented to display user interface components 911, 913, 921, and 923. In some embodiments, user interface components 911, 913, 921, and 923 represent the expected and correct locations for mechanical joints such as flange joints. In the example shown, the locations of joints to be made on object of interest 901 are marked, for example, by hand using a marker. Each X marked on object of interest 901 depicts the location of an intended joint location and can be used to program a robot. Using user interface 900, a user or robot can determine whether the intended (and marked) locations are correct. In the event the locations are incorrect, a robot may be reprogrammed to perform the joints at the correct locations.

In the example shown, user interface components 911 and 913 depict locations on object of interest 901 where the joint is correctly marked. In some embodiments, the user interface component depicts a correctly marked joint when the user interface component overlaps the entirety of the marked joint location. In some embodiments, the user interface component depicts a correctly marked joint when the user interface component overlaps the center of the marked joint location. User interface components 911 and 913 include representations of a tolerance measurement for each joint. For example, in some embodiments, the size of the user interface component represents an allowable deviation from the center of the joint. In some embodiments, user interface components 911 and 913 represent correctly marked joints and are displayed as circular shapes where the volume of the circular shapes represents the allowable deviation before the marked joint is incorrect. In various embodiments, the circular shapes are rendered as spherical visual indicators. In some embodiments, the radius of circular shapes represents an allowable deviance from a reference property. In some embodiments, user interface components 911 and 913 represent correctly marked joints and are displayed as circles where the area of the circle represents the allowable deviation before the marked joint is incorrect.

In the example shown, user interface components 921 and 923 depict locations on object of interest 901 where the marked joint is incorrect. As depicted in FIG. 9, user interface components 921 and 923 are offset from the marked joint locations. The center of the marked locations (i.e., the center of the marked X) do not overlap any portions of user interface components 921 and 923. In some embodiments, user interface components 921 and 923 are user interface overlays where the correct joint locations do not match the physical marked locations.

In some embodiments, user interface components such as user interface components 911, 913, 921, and 923 include movement to represent a state associated with the underlying feature. For example, in some embodiments, a user interface component vibrates when the location of the feature, such as a joint location, is being determined and additional computation and/or data (e.g., additional view images) is needed before determining the feature's location. In some embodiments, a vibrating user interface component represents a feature that has been identified or detected but where the exact location of the feature is still being determined. In some embodiments, vibration is implemented by blinking and/or turning on and off the user interface component. In some embodiments, the user interface component expands and contracts while focusing on the feature's location. In some embodiments, the user interface component blinks or alternates turning on and off to indicate a detected feature has been identified but that additional information and/or processing is needed to determine the feature's precise location. Additional appropriate user interface techniques can be utilized to represent the need for additional image data such as changing the color, shading, and/or translucency, etc. of the user interface component. For example, the color of the user interface component can change as additional image data is captured and processed to determine the feature's location on the surface of the object of interest. In some embodiments, visual indicators correspond to a state associated with a feature. For example, a user interface component rendered in red represents an incorrectly marked joint location and a user interface component rendered in blue represents a correctly marked joint location.

In some embodiments, data corresponding to the feature is included in the display of the user interface component. For example, a description (such as a number, string, descriptive label, etc.) can be displayed to describe a property of the feature such as the type of joint, the assembly order, a ranking of the quality of the joint, a deviation from the acceptable tolerances, a feature identifier, etc. In the example shown, user interface components 921 and 923 each include an identifier (“3”). In various embodiments, a user interfaces with the user interface components 911, 913, 921, and 923 using a touch screen, voice commands, or another appropriate input method.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining an image;
generating a model of the image based on hues of the image;
receiving a reduced model associated with a manufactured item, wherein the reduced model associated with the manufactured item has been generated by reducing an original model associated with the manufactured item; and
attempting to match at least a portion of the reduced model with the model of the image.

2. The method of claim 1, wherein the manufactured item is an automotive part.

3. The method of claim 1, wherein the original model includes a computer aided design model identifying at least a portion of a three-dimensional shape having a solid interior region.

4. The method of claim 1, wherein the reduced model is generated by removing a portion of the original model corresponding to one or more solid interior regions of the original model.

5. The method of claim 1, wherein the reduced model is generated by excluding a portion of the original model corresponding to a solid interior region of the original model.

6. The method of claim 1, wherein the reduced model is generated by excluding a portion of the original model corresponding to a thickness parameter of the original model.

7. The method of claim 1, wherein the reduced model includes one or more surface equations of the original model.

8. The method of claim 7, wherein attempting to match at least the portion of the reduced model with the model of the image includes utilizing the one or more surface equations to determine whether a plurality of surface points fit the reduced model.

9. The method of claim 1, wherein a plurality of depths associated with a plurality of surface points on the manufactured item are determined based on the hues of the image.

10. The method of claim 1, wherein generating the model of the image based on hues of the image includes comparing a hue value associated with a surface point to a threshold value to determine a depth value.

11. The method of claim 1, wherein generating the model of the image based on hues of the image includes determining whether a difference between neighboring hue values of the image exceeds a threshold value to identify a region of light contrast in the image.

12. The method of claim 1, wherein the image includes a reference marker that has been captured in the image.

13. The method of claim 12, wherein the reference marker is a 3D marker, a sticker, a QR code, or a radio-frequency identification tag.

14. The method of claim 12, wherein attempting to match at least the portion of the reduced model with the model of the image includes identifying a reference location based on the reference marker.

15. The method of claim 12, wherein the reference marker is used to determine an object type of the manufactured item.

16. The method of claim 1, further comprising detecting a feature of the manufactured item in the image.

17. The method of claim 16, wherein the detected feature is one or more of the following: a mechanical joint, a spot weld, a self-pierced rivet, a laser weld, a structural adhesive, or a sealer.

18. The method of claim 16, wherein the detected feature is an interface between the manufactured item and a second manufactured item.

19. A computer program product, the computer program product being embodied in a non-transitory computer readable storage medium and comprising computer instructions for:
obtaining an image;
generating a model of the image based on hues of the image;
receiving a reduced model associated with a manufactured item, wherein the reduced model associated with the manufactured item has been generated by reducing an original model associated with the manufactured item; and
attempting to match at least a portion of the reduced model with the model of the image.

20. A system, comprising:
a processor;
a display;
a reference data store;
a camera;
a plurality of device positioning sensors; and
a memory coupled with the processor, wherein the memory is configured to provide the processor with instructions which when executed cause the processor to:
obtain an image using the camera;
generate a model of the image based on hues of the image;
receive a reduced model associated with a manufactured item, wherein the reduced model associated with the manufactured item has been generated by reducing an original model associated with the manufactured item; and
attempt to match at least a portion of the reduced model with the model of the image.
